(19) United States
(12) Patent Application Publication
(10) Pub. No.: US 2023/0374832 A1
(43) Pub. Date: Nov. 23, 2023

(54) COMPRESSION LATCH

(71) Applicant: Southco, Inc., Concordville, PA (US)

(72) Inventor: Brandon V. Hastings, Hemlock, NY (US)

(73) Assignee: Southco, Inc., Concordville, PA (US)

(21) Appl. No.: 18/028,267

(22) PCT Filed: Sep. 23, 2021
(86) PCT No.: PCT/US2021/051711

§ 371 Date: Mar. 24, 2023

Related U.S. Application Data
(60) Provisional application No. 63/083,300, filed on Sep. 25, 2020.

(51) Int. Cl. E05C 5/04; E05C 3/00; E05C 3/04; E05B 17/00; E05B 41/00

(52) U.S. Cl. CPC E05C 5/04; E05C 3/004; E05C 3/041; E05B 17/0025; E05B 41/00

(57) ABSTRACT

According to one aspect of the invention, a latch is configured to fix a panel relative to a frame. The latch includes a housing configured for engagement to the panel. The housing defines an aperture extending along a longitudinal axis, and further defines a cam surface facing in a direction along the longitudinal axis. A shaft extends within the aperture of the housing and along the longitudinal axis. The shaft is mounted for at least one of rotational movement relative to the housing about the longitudinal axis and axial movement relative to the housing along the longitudinal axis. A barrier wall is mounted for axial movement relative to the housing along the longitudinal axis. The barrier wall at least partially overlaps with the housing along the longitudinal axis. A shaft surface extends radially outwardly from the shaft relative to the longitudinal axis. The shaft surface contacts the cam surface defined by the housing. The shaft is configured to be coupled to a pawl for engagement of the frame. The cam surface defined by the housing is configured to guide the movement of the shaft relative to the housing along the longitudinal axis or about the longitudinal axis as the shaft is moved within the aperture defined by the housing along the longitudinal axis or about the longitudinal axis and as the shaft surface of the shaft and the cam surface of the housing move relative to one another, such that the pawl can engage or disengage the frame. The barrier wall and the housing move relative to one another along the longitudinal axis in a range of relative positions, and the barrier wall and housing together inhibit the ingress of unwanted materials into the aperture of the housing throughout the range of relative positions.

### CROSS-REFERENCE TO RELATED APPLICATIONS

This application claims priority to U.S. Provisional Patent Application No. 63/083,300, filed on Sep. 25, 2020, titled “COMPRESSION LATCH,” the entirety of which is incorporated by reference herein for all purposes.

### FIELD OF THE INVENTION

The present invention relates generally to latches, and particularly, to compression latches that can be used for securing storage compartments.

### BACKGROUND OF THE INVENTION

Conventionally, storage compartments in restricted areas (such as medical environments for example) must be secured to prevent unauthorized access to their contents. Latches may be used to restrict access to such compartments to users having a corresponding key. Although compression latches have been proposed for this and other uses, there remains a need for compression latches having at least one of improved performance, reduced cost, or ease of manufacture.

### SUMMARY OF THE INVENTION

Aspects of the present invention are related to latches. According to one aspect of the invention, a latch is configured to fix a panel relative to a frame. The latch includes a housing configured for engagement to the panel. The housing defines an aperture extending along a longitudinal axis, and further defines a cam surface facing in a direction along the longitudinal axis. A shaft extends within the aperture of the housing and along the longitudinal axis. The shaft is mounted for at least one of rotational movement relative to the housing about the longitudinal axis and axial movement relative to the housing along the longitudinal axis. A barrier wall is mounted for axial movement relative to the housing along the longitudinal axis. The barrier wall at least partially overlaps with the housing along the longitudinal axis. A shaft surface extends radially outwardly from the shaft relative to the longitudinal axis. The shaft surface contacts the cam surface defined by the housing. The shaft is configured to be coupled to a pawl for engagement of the frame. The cam surface defined by the housing is configured to guide the movement of the shaft relative to the housing along the longitudinal axis or about the longitudinal axis as the shaft is moved within the aperture defined by the housing along the longitudinal axis or about the longitudinal axis and as the shaft surface of the shaft and the cam surface of the housing move relative to one another, such that the pawl can engage or disengage the frame. The barrier wall and the housing move relative to one another along the longitudinal axis in a range of relative positions, and the barrier wall and housing together inhibit the ingress of unwanted materials into the aperture of the housing throughout the range of relative positions.

According to another aspect of the invention, a latch is configured for fixing a panel relative to a frame, the latch having an engaged position in which the panel is fixed relative to the frame and a disengaged position in which the panel is not fixed relative to the frame. The latch includes a housing having a proximal end portion configured for engagement to the panel, the housing having a longitudinal axis. A shaft extends along the longitudinal axis. The shaft and the housing are mounted for rotation relative to one another about the longitudinal axis, and the shaft and the housing further being mounted for axial movement relative to one another. A pawl is coupled to a distal end portion of the shaft, and the pawl is configured to engage the frame. A cam surface is defined by the housing. The cam surface being configured to guide the axial movement of the shaft relative to the housing, such that the pawl engages or disengages the frame. The shaft and the pawl move together toward the proximal end of the housing upon rotation of the shaft relative to the housing as the latch transitions from the disengaged position toward the engaged position, thereby compressing the panel and the frame relative to one another.

According to still another aspect of the invention, a latch is configured to fix a panel relative to a frame. The latch includes a housing configured for engagement to the panel. The housing has a longitudinal axis and an inner surface defining an aperture extending along the longitudinal axis. The housing further defines a cam surface on the inner surface of the housing and facing in a direction along the longitudinal axis. The cam surface and the housing are integrally formed as a single body of unitary construction. A shaft extends within the aperture of the housing and along the longitudinal axis. The shaft is mounted for rotation relative to the housing about the longitudinal axis. The shaft is mounted for axial movement relative to the housing along the longitudinal axis. The shaft has a shaft body and a shaft surface extending radially outwardly from the shaft body relative to the longitudinal axis. The shaft surface contacts the cam surface defined by the housing. A pawl is coupled to the shaft, and the pawl is configured to engage the frame. The cam surface defined by the housing is configured to guide the axial movement of the shaft relative to the housing along the longitudinal axis as the shaft is rotated within the aperture defined by the housing about the longitudinal axis and as the shaft surface of the shaft and the cam surface of the housing move relative to one another, such that the pawl engages or disengages the frame.

According to yet another aspect of the invention, a latch is configured to fix a panel relative to a frame. The latch includes a housing configured for engagement to the panel, the housing having a longitudinal axis and an inner surface defining an aperture extending along the longitudinal axis from a proximal end of the housing to a distal end of the housing. The housing further defines or provides a cam surface facing in a proximal direction toward the proximal end of the housing along the longitudinal axis. A shaft extends within the aperture of the housing and along the longitudinal axis. The shaft is mounted for movement relative to the housing. A cam follower is coupled to the shaft for movement with the shaft relative to the housing, the cam follower having a surface extending radially outwardly from the shaft body relative to the longitudinal axis. The surface of the cam follower contacts the cam surface defined by the housing. The shaft is configured for insertion distally into the aperture of the housing from the proximal end of the housing toward the distal end of the housing, and the cam follower is configured for insertion distally into the aperture of the housing from the proximal end of the housing toward the distal end of the housing. The shaft and the cam follower are prevented from insertion proximally into the aperture of the housing from the distal end of the housing toward the proximal end of the housing and from withdrawal distally from the aperture of the housing through the distal end of the housing. The shaft and the cam follower are each insertable into the aperture of the housing in the distal direction.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features may be arbitrarily expanded or reduced for clarity. Included in the drawings are the following figures:

FIG. 1A depicts a perspective view of an embodiment of a latch assembly.

FIG. 1B depicts a top view of the assembly.

FIG. 1C depicts a front view of the assembly.

FIG. 1D depicts a side view of the assembly.

FIG. 2 depicts an exploded view of the assembly.

FIG. 3A depicts a perspective view of an embodiment of a housing.

FIG. 3B depicts a top view of the housing.

FIG. 3C depicts a bottom view of the housing.

FIG. 3D depicts a side view of the housing.

FIG. 3E depicts a cross-sectional side view of the housing, taken along line 3E-3E.

FIG. 3F depicts a front elevational view of the housing.

FIG. 4A depicts a perspective view of an embodiment of a shaft.

FIG. 4B depicts a top view of the shaft.

FIG. 4C depicts a side elevational view of the shaft.

FIG. 4D depicts a cross-sectional view of the shaft, taken along line 4D-4D.

FIG. 5A is a perspective view of an embodiment of a pin.

FIG. 5B is a side view of the pin.

FIG. 5C is an end view of the pin.

FIG. 6 is perspective view of an embodiment of a spring.

FIG. 7A is a perspective view of an embodiment of a pawl assembly.

FIG. 7B is a side view of the pawl assembly.

FIG. 7C is a front end view of the pawl assembly.

FIG. 7D is a rear end view of the pawl assembly.

FIG. 7E is an exploded view of the pawl assembly.

FIG. 8A is top view of an embodiment of a latch assembly, when it is in an unlatched state.

FIG. 8B is a cross-sectional view of the latch assembly of FIG. 8A, taken along line 8B-8B, showing an unlatched state.

FIG. 9A is top view of the latch assembly, when it is in a latched state.

FIG. 9B is a cross-sectional view of the latch assembly of FIG. 9A, taken along line 9B-9B, showing a latched state.

FIG. 10A is a front view of an embodiment of a latch system, when it is in an uncompressed (unsecured or unlocked) state.

FIG. 10B is a front view of the assembly of FIG. 10A, in an intermediate position between the uncompressed state and the compressed state.

FIG. 10C is a front view of the assembly of FIG. 10A, when it is in a compressed (secured or locked) state.

FIG. 10D is a perspective view of the assembly of FIG. 10A.

FIG. 10E is a perspective view of the assembly of FIG. 10C.

FIGS. 11A-11C depict various pawl options in accordance with embodiments of the present invention.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The exemplary latches described herein can provide for compression and have at least one of improved performance, reduced cost, or ease of manufacture.

While particular latch embodiments are described herein, components of the disclosed embodiments may be incorporated into any conventional latches known to one of ordinary skill in the art to achieve the advantages described herein. For example, components of the disclosed embodiments may be incorporated into those latches described in U.S. Pat. No. 4,583,775, the contents of which are incorporated herein by reference in their entirety. Likewise, the disclosed latches may be usable on any structure, including any type of storage compartments in which it is desirable to secure the contents of the compartment.

The latch is preferably a compression latch for use with a panel mounted to a frame. Such a compression latch is configured for movement from an open position in which a panel is not latched relative to the frame, to a latched position in which the panel is latched relative to the frame, and to a locked position in which the panel is pulled against the frame such that they are compressed against one another.

Referring generally to the figures, and according to one aspect of the invention, a latch 100 is configured to fix a panel 106 relative to a frame 108. The latch 100 includes a housing 110 configured for engagement to the panel 106. The housing 110 defines an aperture 112 extending along a longitudinal axis 102, and further defines a cam surface 180 facing in a direction along the longitudinal axis 102. A shaft 120 extends within the aperture 112 of the housing 110 and along the longitudinal axis 102. The shaft 120 is mounted for at least one of rotational movement relative to the housing 110 about the longitudinal axis 102 and axial movement relative to the housing 110 along the longitudinal axis 102. A barrier wall, such as the wall of cup 130, is mounted for axial movement relative to the housing 110 along the longitudinal axis 102. The barrier wall at least partially overlaps with the housing 110 along the longitudinal axis 102. A shaft surface, such as a surface of an end portion of pin 150, extends radially outwardly from the shaft 120 relative to the longitudinal axis 102. The shaft surface contacts the cam surface 180 defined by the housing 110. The shaft 120 is configured to be coupled to a pawl 160 for engagement of the frame 108. The cam surface 180 defined by the housing 110 is configured to guide the movement of the shaft 120 relative to the housing 110 along the longitudinal axis 102 or about the longitudinal axis 102 as the shaft 120 is moved within the aperture 112 defined by the housing 110 along the longitudinal axis 102 or about the longitudinal axis 102 and as the shaft surface of the shaft 120 and the cam surface 180 of the housing 110 move relative to one another, such that the pawl 160 can engage or disengage the frame 108. The barrier wall and the housing 110 move relative to one another along the longitudinal axis 102 in a range of relative positions, and the barrier wall and housing 110 together inhibit the ingress of unwanted materials into the aperture 112 of the housing 110 throughout the range of relative positions.

The shaft 120 includes an optional drive stud 122 extending along the longitudinal axis 102 and defining a drive surface 124 for rotating the shaft 120 relative to the housing 110. The drive stud 122 is provided with an optional directional indicator 126 corresponding to a position of the pawl 160. The shaft surface of the shaft 120 is defined on an optional pin 150 extending radially outwardly from the shaft 120 relative to the longitudinal axis 102.

The shaft 120 is coupled to the pawl 160 for engagement of the frame 108, and the pawl 160 extends radially outwardly from the shaft 120 relative to the longitudinal axis 102 along a radial axis, such as the radial axis extending along axle 166. The pawl 160 includes an optional roller 162 mounted for rotational movement about the radial axis. Alternatively, the pawl 160 includes a surface 164.

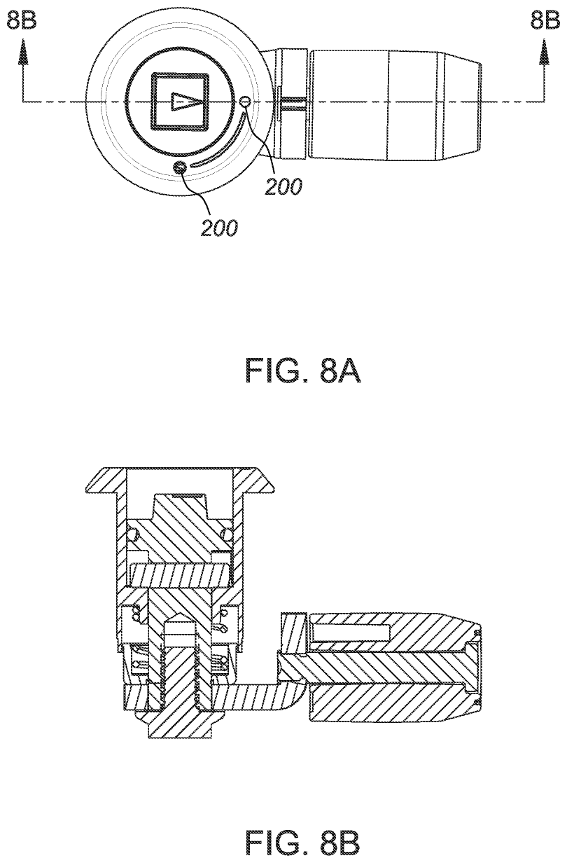

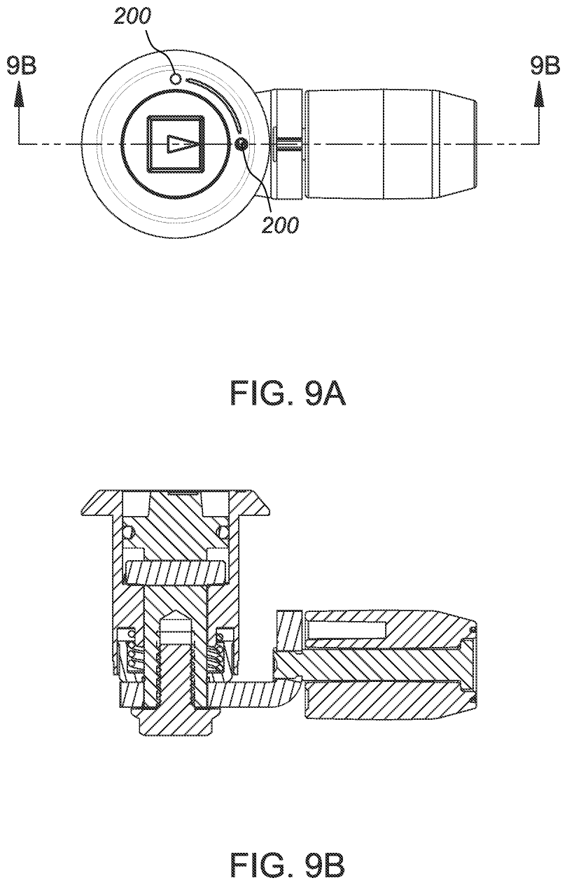

The cam surface 180 of the housing 110 includes a plurality of optional sections 182, 184, 186, each section being configured to guide the movement of the shaft 120 between a latched position (e.g., the position of FIG. 9B) and an unlatched position (e.g., the position of FIG. 8B). The housing 110 is provided with an optional indicator arrangement 200, the indicator arrangement 200 corresponding to at least one of the unlatched position or the latched position.

The cam surface 180 and the housing 110 are optionally integrally formed as a single body of unitary construction. The housing 110 includes an optional recess 188 configured to at least partially receive the barrier wall.

The latch 100 includes an optional spring 140 interposed between a surface of the housing 110 and another surface of the latch 100, in one embodiment the other surface being the surface of a cup 130, but the other surface may be a surface of another component such as pawl 160, screw 170, or another component. The spring 140 is configured to bias the housing 110 away from the other surface along the longitudinal axis 102, and the spring 140 is compressed as the shaft 120 rotates toward a latched position.

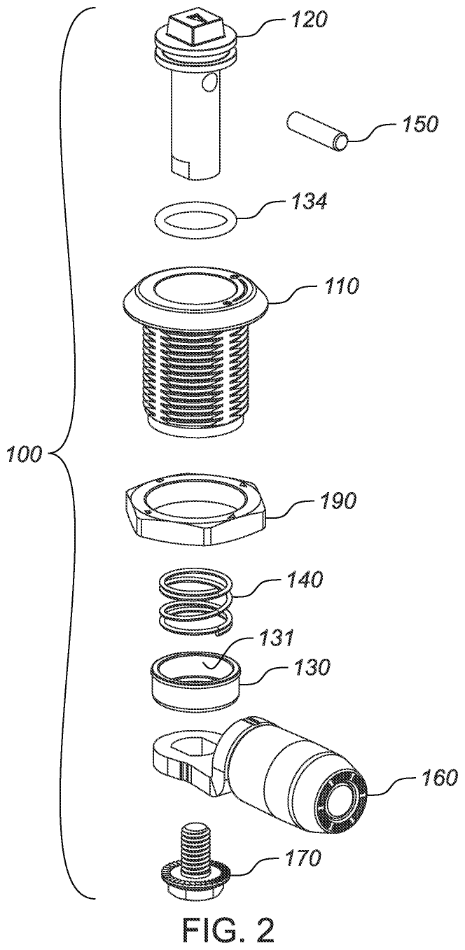

According to another aspect of the invention, a latch 100 is configured for fixing a panel 106 relative to a frame 108, the latch 100 having an engaged position in which the panel 106 is fixed relative to the frame 108 and a disengaged position in which the panel 106 is not fixed relative to the frame 108. The latch 100 includes a housing 110 having a proximal end portion, including an optional flange 116, configured for engagement to the panel 106, and the housing 110 has a longitudinal axis 102. There may be an optional sealing gasket (not shown) between the flange 116 and the panel 106. A shaft 120 extends along the longitudinal axis 102. The shaft 120 and the housing 110 are mounted for rotation relative to one another about the longitudinal axis 102, and the shaft 120 and the housing 110 are mounted for axial movement relative to one another. A pawl 160 is coupled to a distal end portion (e.g., the bottom end portion of shaft 120 in the orientation illustrated in FIG. 2) of the shaft 120, and the pawl 160 is configured to engage the frame 108. A cam surface 180 is defined by the housing 110. The cam surface 180 is configured to guide the axial movement of the shaft 120 relative to the housing 110, such that the pawl 160 engages or disengages the frame 108. The shaft 120 and the pawl 160 move together toward the proximal end (e.g., the top end of housing 110 in the orientation of FIG. 2) of the housing 110 upon rotation of the shaft 120 relative to the housing 110 as the latch 100 transitions from the disengaged position toward the engaged position, thereby compressing the panel 106 and the frame 108 relative to one another.

The latch 100 includes an optional barrier wall (e.g., an annular wall or wall portion of cup 130, a wall formed to extend upwardly from pawl 160, etc.) mounted for axial movement relative to the housing 110. The housing 110 includes an optional recess 188 configured to selectively receive at least a portion of the barrier wall.

The latch 100 includes an optional spring 140, wherein axial movement of the pawl 160 relative to the housing 110 is configured to move the spring 140 between an extended state (e.g., FIG. 8B) and a compressed state (e.g., FIG. 9B). The spring 140 is interposed between a surface of the housing 110 and another surface (e.g., a surface of cup 130, a surface of pawl 160, etc.) of the latch 100 and is configured to bias the housing 110 away from the other surface along the longitudinal axis 102. The pawl 160 engages or disengages the frame 108 as the spring 140 moves between the extended state and the compressed state.

The shaft 120 includes an optional driver 122 configured for engagement by a tool. The driver 122 moves along the longitudinal axis 102 as the shaft 120 rotates relative to the housing 110. The driver 122 could be male or female and configured for engagement with various tool types.

The latch 100 also includes an optional pin 150 extending radially outwardly from the shaft 120 relative to the longitudinal axis 102. The pin 150 is configured to contact the cam surface 180 as the shaft 120 and the housing 110 rotate relative to one another about the longitudinal axis 102.

A latch system includes the latch 100, a panel 106 engaged to the housing 110, a frame 108 positioned for engagement by the pawl 160, and a gasket 109 interposed between the panel 106 and the frame 108. The pawl 160 compresses the gasket 109 as the shaft 120 and the pawl 160 move together toward the proximal end portion of the housing 110 upon rotation of the shaft 120 relative to the housing 110 as the latch 100 transitions from the disengaged position toward the engaged position.

According to still another aspect of the invention, a latch 100 is configured to fix a panel 106 relative to a frame 108. The latch 100 includes a housing 110 configured for engagement to the panel 106. The housing 110 has a longitudinal axis 102 and an inner surface defining an aperture 112 extending along the longitudinal axis 102. The housing 110 further defines a cam surface 180 on the inner surface of the housing 110 and facing in a direction along the longitudinal axis 102. The cam surface 180 and the housing 110 are integrally formed as a single body of unitary construction. A shaft 120 extends within the aperture 112 of the housing 110 and along the longitudinal axis 102. The shaft 120 is mounted for rotation relative to the housing 110 about the longitudinal axis 102. The shaft 120 is also mounted for axial movement relative to the housing 110 along the longitudinal axis 102. The shaft 120 has a shaft body and a shaft surface extending radially outwardly from the shaft body relative to the longitudinal axis 102. The shaft surface contacts the cam surface 180 defined by the housing 110. A pawl 160 is coupled to the shaft 120, and the pawl 160 is configured to engage the frame 108. The cam surface 180 defined by the housing 110 is configured to guide the axial movement of the shaft 120 relative to the housing 110 along the longitudinal axis 102 as the shaft 120 is rotated within the aperture 112 defined by the housing 110 about the longitudinal axis 102 and as the shaft surface of the shaft 120 and the cam surface 180 of the housing 110 move relative to one another, such that the pawl 160 engages or disengages the frame 108.

The latch 100 includes an optional spring 140 adjacent a surface of the housing 110. The spring 140 is configured to bias the housing 110 in a direction along the longitudinal axis 102. The latch 100 also includes an optional cup 130 mounted for axial movement relative to the housing 110 along the longitudinal axis 102. The cup 130 provides a barrier wall and defines an annular recess, such as an interior region of the cup 130. The spring 140 is optionally interposed between the surface of the housing 110 and a surface of the cup 130 and extends into the annular recess of the cup 130. The spring 140 is configured to bias the housing 110 away from the cup 130 along the longitudinal axis 102.

The cam surface 180 defined by the housing 110 optionally includes a plurality of sections 182, 184, 186. Each section is configured to help guide the axial movement of the shaft 120 between a latched position and an unlatched position. The shaft surface of the shaft 120 is defined on an optional pin 150 extending radially outwardly from the shaft body relative to the longitudinal axis 102.

Upon rotation of the shaft 120 relative to the housing 110 as the latch 100 transitions from a disengaged position toward an engaged position, the shaft 120 and the pawl 160 move together toward a housing mounting plane (the plane at which the housing 110 is configured to be mounted to the panel 106). The panel 106 and the frame 108 are thereby compressed relative to one another.

A position of a proximal end (top in FIG. 2) of the shaft 120 relative to the proximal end portion (top end portion in FIG. 2) of the housing 110 optionally provides a compression indicator (see, e.g., FIGS. 8B and 9B). The compression indicator provided by the position of the proximal end of the shaft 120 relative to the proximal end portion of the housing 110 indicates compression when the proximal end (e.g., top shown in FIG. 2) of the shaft 120 corresponds in position to a proximal end (e.g., top shown in FIG. 2) of the housing 110, or the proximal end of the shaft 120 and the proximal end of the housing 110 are within a predetermined spacing. The compression indicator indicates incomplete compression (or no compression) when the proximal end of the shaft 120 is spaced distally away from the proximal end of the housing 110, or the proximal end of the shaft 120 and the proximal end of the housing 110 exceed the predetermined spacing.

The spacing (or lack of spacing) between the proximal end of the shaft 120 and the proximal end of the housing 110 can therefore indicate whether or not there is adequate compression or the position of the latch (latched or unlatched). Also, the difference in spacing between the proximal end of the shaft 120 and the proximal end of the housing 110, when the latch is in the opened and closed positions, is also an indicator of the degree of compression. In one embodiment, the latch has a travel of approximately 4 mm, so the spacing between the head of the housing (or proximal end of the housing 110) and top of the pawl providing the compressive function (pawl 160) will decrease by approximately 4 mm between the unsecure and secure states of the latch.

Also, the driver portion of the shaft (top or proximal end of the shaft 120) moves axially relative to the housing 110. Accordingly, there are two indications that the latch is secure. First, the indicator 126 on the head of the shaft 120 corresponds with the appropriate indicator 200 on the top of the housing 110. Second, the top of the square or driver portion of the shaft 120 will be coplanar with the top of the housing 110.

Regarding the size of the predetermined spacing between the proximal end of the shaft 120 and the proximal end of the housing 110 when there is incomplete compression (or no compression), the spacing can be selected depending on the application for the latch. For example, adequate compression can be indicated when the spacing between proximal end of the shaft 120 and the proximal end of the housing 110 is preferably less than 2 mm, more preferably less than 1 mm. Also, inadequate compression is indicated when the spacing between proximal end of the shaft 120 and the proximal end of the housing 110 is greater than 2 mm, more preferably 4 mm or greater.

One of the plurality of sections 182, 184, 186 of the cam surface 180 defines a recess 184 positioned to receive the shaft surface, such as a surface of pin 150, of the shaft 120. The recess 184 is configured to releasably retain the shaft 120 in a predetermined position or to provide haptic feedback to a user of the latch 100 regarding the predetermined position.

The housing 110 is die cast, machined, injection molded, or printed. Other forming methods are also contemplated.

The cam surface 180 of the housing 110 is co-molded or pressed into the housing 110. Other forming methods are also contemplated.

The housing 110 is formed from zinc or metal injection molded steel. Other materials and material combinations are also contemplated. The shaft 120 and the housing 110 are optionally formed from the same material or materials. The shaft surface of the shaft 120 is optionally formed from hardened steel.

The directional indicator 126 indicates the position of the pawl 160 in every position of the pawl 160. A torque required to rotate the shaft 120 relative to the housing 110 and to compress the panel 106 relative to the frame 108 is optionally 7.9 Nm or less, thereby permitting hand-rotation of the shaft 120 relative to the housing 110 and compression of the panel 106 relative to the frame 108.

The torque required to operate the latch is proportional to the compressive load. For example, a preferred torque of approximately 5 Nm of nominal operating torque, or less, is optionally selected. There can be lighter panel loads and/or lower compression loads that will be less or significantly less than 5 Nm. With higher panel loads the torque will increase. The torque can be provided with an upper limit of 7.9 Nm, for example, because that may be a maximum ergonomic torque that a typical user can apply by hand.

According to yet another aspect of the invention, a latch 100 is configured to fix a panel 106 relative to a frame 108. The latch 100 includes a housing 110 configured for engagement to the panel 106, the housing 110 having a longitudinal axis 102 and an inner surface defining an aperture 112 extending along the longitudinal axis 102 from a proximal end (top in FIG. 2) of the housing 110 to a distal end (bottom in FIG. 2) of the housing 110. The housing 110 further defines or provides a cam surface 180 facing in a proximal direction (upward in FIG. 2) toward the proximal end of the housing 110 along the longitudinal axis 102. A shaft 120 extends within the aperture 112 of the housing 110 and along the longitudinal axis 102. The shaft 120 is mounted for movement relative to the housing 110. A cam follower (e.g., pin 150) is coupled to the shaft 120 for movement with the shaft 120 relative to the housing 110, the cam follower having a surface extending radially outwardly from the shaft body relative to the longitudinal axis 102. The surface of the cam follower contacts the cam surface 180 defined by the housing 110. The shaft 120 is configured for insertion distally (downward in FIG. 2) into the aperture 112 of the housing 110 from the proximal end of the housing 110 toward the distal end of the housing 110, and the cam follower is configured for insertion distally into the aperture 112 of the housing 110 from the proximal end of the housing 110 toward the distal end of the housing 110. The shaft 120 and the cam follower are prevented from insertion proximally (upward in FIG. 2) into the aperture 112 of the housing 110 from the distal end of the housing 110 toward the proximal end of the housing 110 and from withdrawal distally from the aperture 112 of the housing 110 through the distal end of the housing 110. The shaft 120 and the cam follower are each insertable into the aperture 112 of the housing 110 in the distal direction.

In this aspect of the invention, all components of the latch can optionally be assembled along one direction. For example, referring to FIG. 2, all components of the latch can be assembled in a top down direction. In one assembly procedure, pawl 160 is placed downwardly over the threads of screw 170, cup 130 is placed downwardly on pawl 160, spring 140 is placed downwardly on cup 130, mounting nut 190 is placed downwardly over cup 130, housing is placed downwardly over the spring 140, and the shaft 120 (with pin 150 and o-ring 134) are placed downwardly within the housing 110 and engaged by the screw 170. Although pin 150 is pre-inserted into shaft 120 in a direction transverse to the shaft 120, pin 150 is also assembled together with shaft 120 in a top down direction.

The cam surface 180 and the housing 110 are optionally integrally formed as a single body of unitary construction. The cam follower is optionally a separate component, such as pin 150, mounted to the shaft 120, and the mounting of the cam follower to the shaft 120 is configured to resist or prevent rotation of the cam follower relative to the shaft 120. The cam follower is optionally a pin 150 extending from an aperture 128 defined in the shaft 120, at least one end of the pin 150 extending radially outwardly from the shaft 120 relative to the longitudinal axis 102.

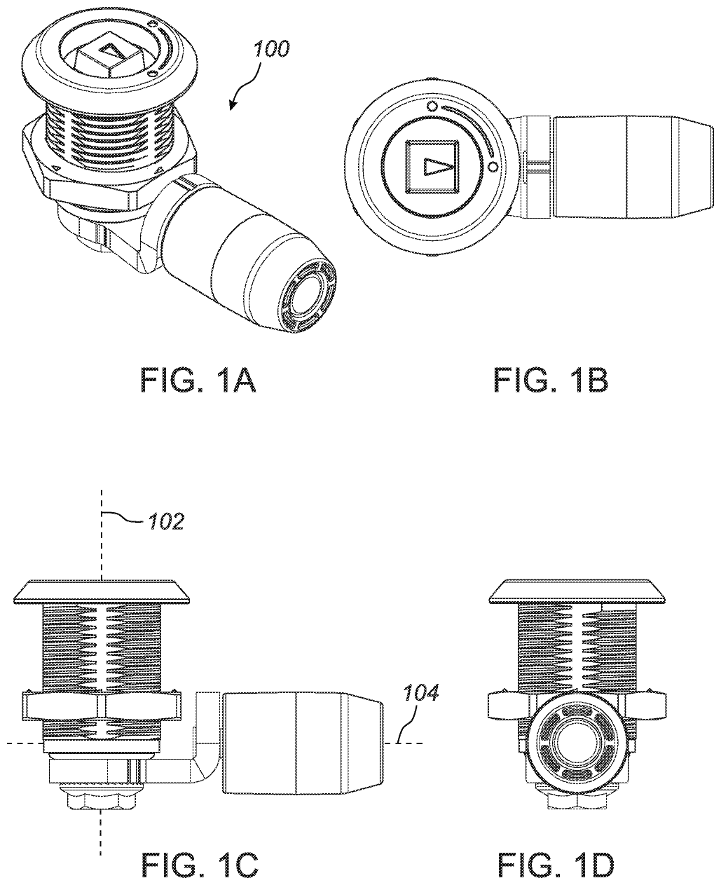

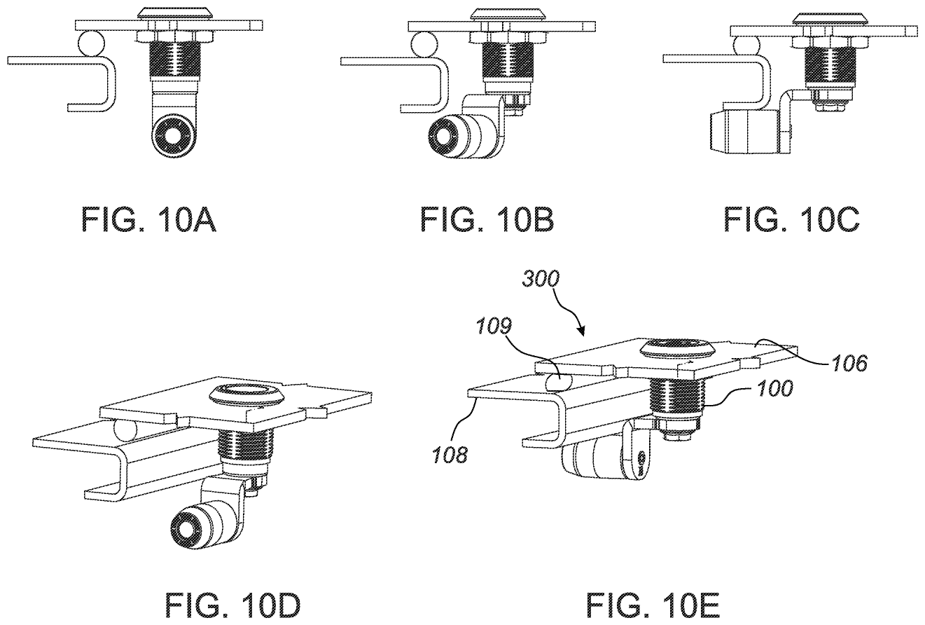

Referring now to specific embodiments selected for illustration in the drawings, FIG. 1 illustrates an exemplary latch 100 in accordance with aspects of the present invention. Latch 100 is configured to fix a panel 106 relative to a frame 108, as shown in FIGS. 10A-10E. As a general overview, latch 100 includes a housing 110, a shaft 120, a cup 130, a spring 140, a pin 150, a pawl 160, and a screw 170. Additional details of latch 100 are described below.

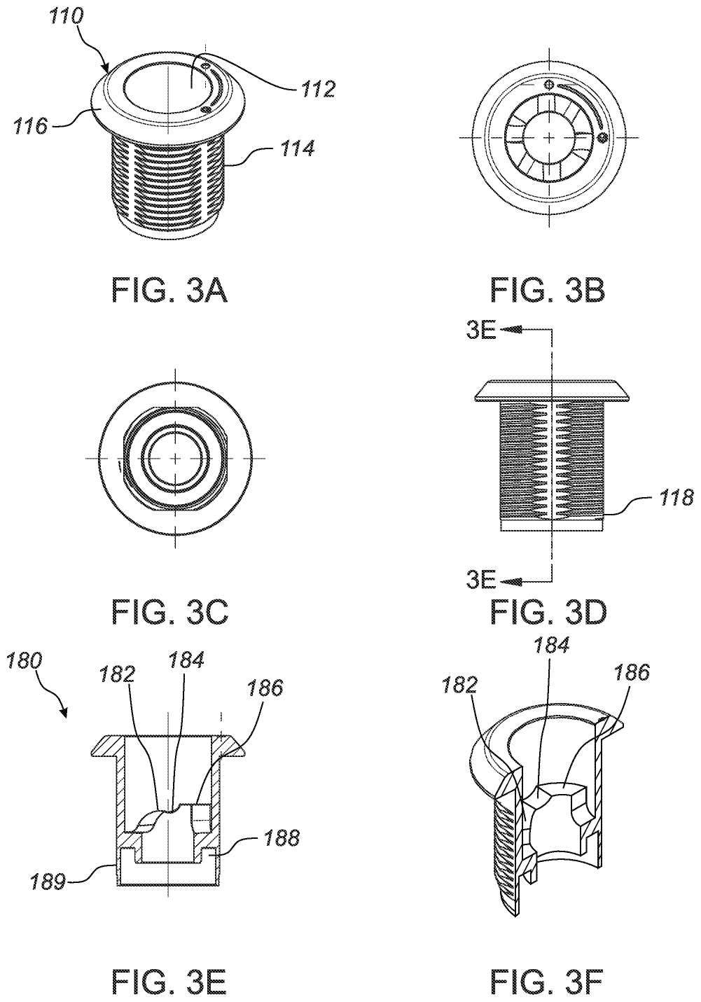

The housing 110 is configured for engagement to the panel 106 at a housing mounting plane in which panel 106 resides. In an exemplary embodiment, as shown in FIGS. 3A-3E, the housing 110 has a body portion 118 sized to fit within a through-hole, typically a double D shaped, in panel 106. Body portion 118 of housing 110 extends along a longitudinal axis 102 (FIG. 3F). As shown in FIGS. 2, 3F, and 10A-10E, the longitudinal axis 102 generally extends in a direction orthogonal to the plane of panel 106. Nonetheless, it will be understood from the description herein that the longitudinal axis 102 may extend at an oblique angle relative to panel 106, and the direction of the longitudinal axis 102 is not intended to be limited.

Additionally, body portion 118 of housing 110 defines an aperture 112 therein which extends along the longitudinal axis 102. Aperture 112 is sized to accommodate several components of latch 100, which are described below. Still further, the housing includes a recess 188 (FIG. 3E) configured to at least partially receive the walls of cup 130.

Cup 130 provides a barrier wall to help seal against, or at least inhibit or reduce, the ingress of unwanted materials into the aperture of the housing. For example, a barrier wall, such as the outer wall or annular wall of cup 130, provides a barrier against the unimpeded ingress of at least some contaminants or debris or moisture from entering the aperture or interior region of the housing.

As described in greater detail below, an o-ring or other form of seal is also provided between the shaft and the housing, thereby impeding ingress of unwanted materials into the aperture of the housing from the top or open end of the housing. Such a seal blocks entry of materials from outside an enclosure to which the latch is mounted. In order to inhibit such ingress from the other or lower end of the housing, the barrier wall (such as that of cup 130) at least partially or fully blocks materials from within or around an enclosure to which the latch is mounted.

A rating, such an IP (or “Ingress Protection”) rating like those defined in international standard EN 60529 (British BS EN 60529:1992), can be used to define levels of sealing effectiveness of enclosures against intrusion from foreign bodies (tools, dirt and other contaminants) and moisture. For example, an enclosure having a latch according to aspects of this invention, can be IP rated to 65 or higher, such that the entire latch system resists ingress. Accordingly, latches according to embodiments of this invention can be used with an IP65 enclosure and considered “dust tight” and protected against water projected from a nozzle. The seals at the top end (e.g., o-ring 134) and/or the bottom end (e.g., barrier wall of cup 130), as oriented for example in FIG. 8B, satisfy an ingress protection rating (such as IP65 or higher) such that the associated enclosures can maintain such a rating.

Additionally, the housing 110 includes a cam surface 180 (FIG. 3E) within the housing 110 and facing along the longitudinal axis 102. As discussed further below, the cam surface 180 defines a path of travel for the pin 150 (FIG. 2); more particularly, the cam surface 180 defines a path of travel for end regions 152 of the pin 150. In a preferred embodiment, a portion or all of the cam surface 180 is formed as an integral or unitary piece with housing 110. Such a structure may be desired in order to further minimize the number of components to be manufactured for latch 100.

Housing 110 further includes a flanged portion 116 extending circumferentially around an outer surface of body portion 118. Flanged portion 116 is sized to contact an inner or outer surface of panel 106 when body portion 118 of housing 110 is received within the through-hole of the panel 106 (as seen in FIGS. 10A-10E).

The flanged portion 116 includes one or more indicators 200 (FIGS. 8A, 9A) that alternate between a first position and a second position in order to indicate whether the latch 100 is in the latched and locked position (FIG. 9A) or the unlatched position (FIG. 8A). Indicators on the housing top can be color coded (e.g., red/green), lit (e.g., by LED), or simply indicate a degree of rotation (e.g., 90 degree) by mechanical or electro-mechanical means.

In the embodiment illustrated in FIGS. 8A-9B, indicators 200 comprise a plurality of notches or other indicia that are spaced approximately equally, i.e. at 90 degrees, about a circumferential surface of flanged portion 116. Further, the plurality of notches may have a different appearances (color, size, shape, etc.) relative to one another.

Other means may be incorporated in a latch 100 according to the present invention for allowing a user to easily recognize whether the latch 100 is in the latched and locked position (FIGS. 9A and 9B) or unlatched position (FIGS. 8A and 8B). For example, the indicators 200 may include a light, such as an LED, or a fluorescent or phosphorescent paint may be applied to at least a portion of the indicator, such that it is illuminated in one of the positions (latched and locked or unlatched and unlocked). The unlatched position in this embodiment corresponds to the position or illuminated condition (FIG. 8A); however, if desired, the position or illuminated indicator of the latch 100 may be reversed, relative to the positions shown in FIGS. 8A-9B.

The housing 110 further includes an outer surface having a means to attach the latch 100 to a panel 106. For example, the means may be in the form of interrupted or uninterrupted screw threads 114 along a portion of the outer surface of the housing 110. As seen in FIGS. 3A-3F, the screw threads 114 on the outer surface of the housing 110 may be interrupted by two or more flats, preferably at least four flats, formed on the outer surface of the housing 110. The flats formed on the outer surface of the housing 110 prevent the rotation of the housing 110 during actuation of the latch 100. The interrupted threads 114 on the outer surface of the housing 110 may be engaged by a nut 190, as described below.

In a preferred embodiment, housing 110 engages with panel 106 using the nut 190. Nut 190 is adapted to be screwed onto threading 114 formed on the outer surface of body portion 118, such that panel 106 is clamped between flanged portion 116 of the housing 110 and nut 190. A washer (not shown) may be added between panel 106 and nut 190 to create an appropriate securement of latch 100 to panel 106. There also may be a sealing gasket (not shown) between the flange 116 and the panel 106. Additionally, a gasket 109 (FIGS. 10A-10E) may be added between panel 106 and the frame 108 to secure the interior of the compartment from external elements such as liquid or dust. The use of nut 190 to secure latch 100 to panel 106 desirably prevents unauthorized removal of latch 100 from panel 106.

Alternatively or additionally, housing 110 may engage with panel 106 by any other means, including for example a frictional or threaded fit of body portion 118 within the through-hole of panel 106 or adhering the flanged portion 116 to the surface of panel 106. For example, a fastener such as a screw can be used as can bracket mounting configurations. Still further, a portion or all of housing 110 may be formed as an integral or unitary piece with panel 106.

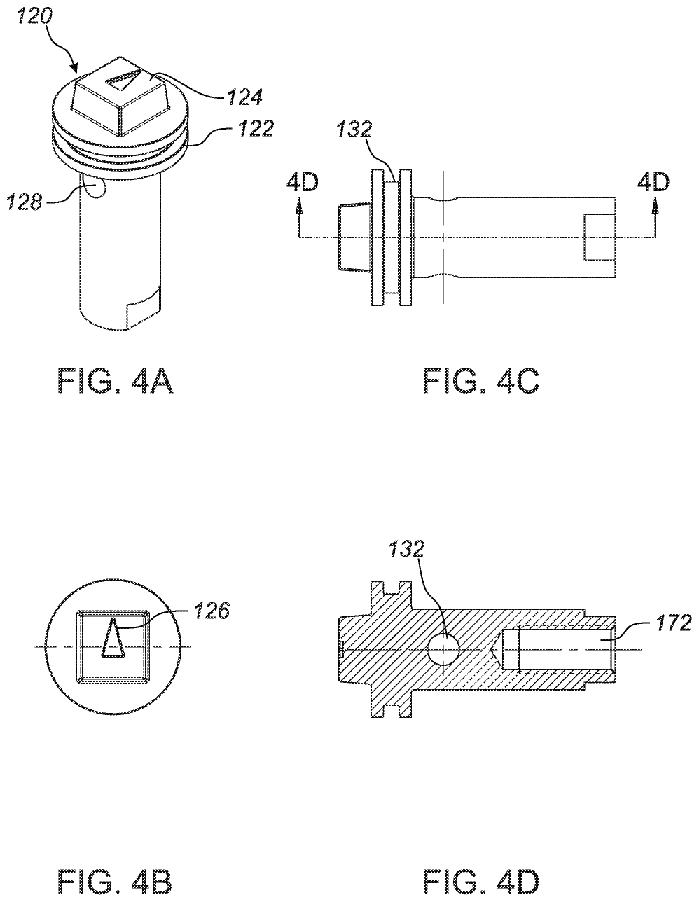

The shaft 120 (illustrated in FIGS. 2A and 4A-4D) extends along the longitudinal axis 102 within the aperture 112 of the housing 110. As seen in FIG. 2A, the shaft 120 comprises a drive stud 122 extending along the longitudinal axis 102 and forming a drive surface 124 for contacting a driver (not shown) and rotating the shaft 120. The drive stud 122 is provided with a directional indicator 126 corresponding to the position or direction of the pawl 160. In an exemplary embodiment, indicators 200, when aligned with the directional indicator 126, indicates to the user that latch 100 is in the unlatched position (FIG. 8A) or the latched and locked position (FIG. 9A).

The shaft 120 may also optionally include an O-ring groove 132 for receiving a gasket, such as an O-ring 134, for sealing part of the shaft 120 from the external environment and prevent, for example, water from entering and freezing within the housing 110, which may damage the latch mechanism, or resist water or dust from passing through the latch and damaging the contents of the compartment. Shaft 120 further includes a through-hole 128. Through-hole 128 extends in the radial direction through the body of shaft 120. Through-hole 128 is shaped to accommodate the pin 150 passing through shaft 120, as described in further detail below. Shaft 120 further includes a threaded recess 172 in a lower end thereof. Threaded recess 172 is sized to accommodate the screw 170 for affixing pawl 160, as described in further detail below.

Still further, the shaft 120 is mounted for rotation about the longitudinal axis 102. In addition, the shaft 120 is mounted for axial movement relative to the housing 110. As shown in FIGS. 4A-4D, shaft 120 may have a cylindrical shape in order to enable unobstructed rotation of shaft 120 within housing 110.

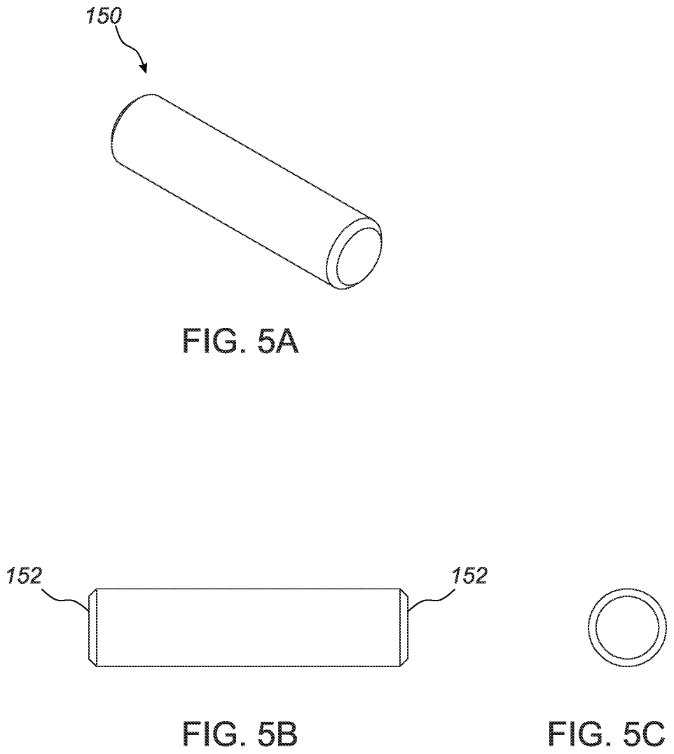

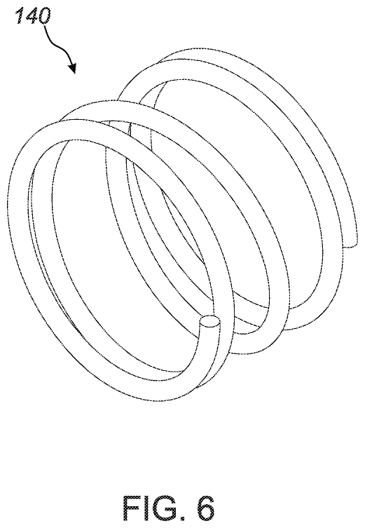

The shaft 120 further includes the through-hole 128, as noted above, which is configured to receive the pin 150 therein. The pin 150 extends radially outwardly from the shaft 120 relative to the longitudinal axis 102. The pin 150 further makes contact with the cam surface 180 defined by the housing 110, as illustrated in FIG. 3E. As a result, shaft 120 is limited to moving rotationally or axially within the path defined by the sliding or rolling engagement of pin 150 along the cam surface 180. In an exemplary embodiment, as seen in FIGS. 5A-5C, pin 150 is a cylindrical post. As seen in FIG. 2, the pin 150 extends diametrically through through-hole 128 of shaft 120. The pin 150 has a length sufficient to form diametrically opposed pin end portions 152 on either side of shaft 120. Alternatively, pin 150 and shaft 120 can be integrally formed.

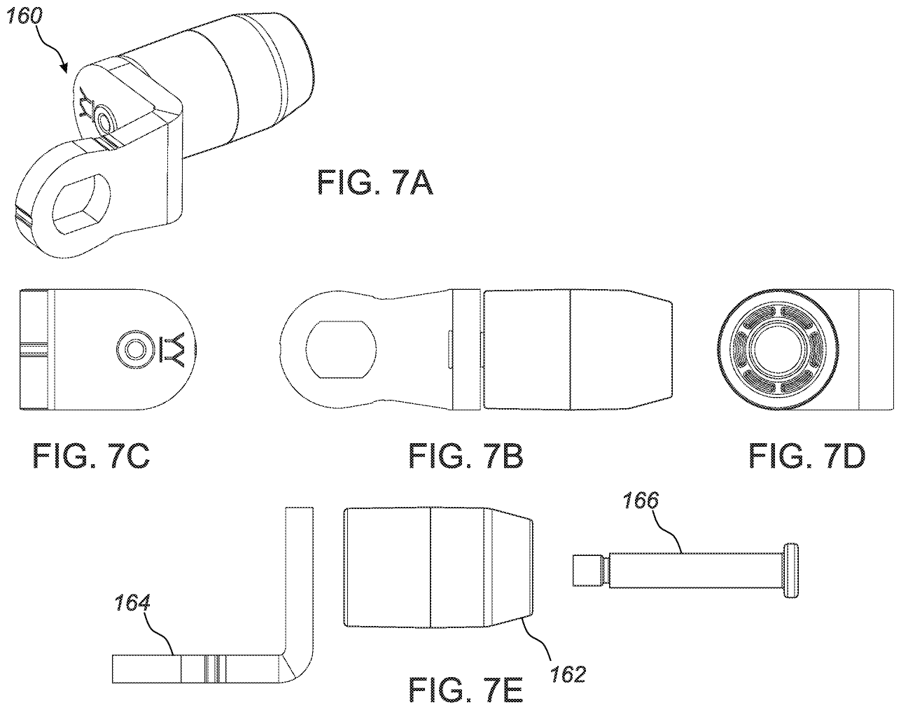

The cup 130 (illustrated in FIG. 2) is mounted for axial movement relative to the housing 110. The cup 130 is configured to rest on a flat or ramped surface 164 (FIG. 7E) of the pawl 160. Still further, the cup 130 is positioned to surround shaft 120. A biasing means, such as the coil spring 140, may be received within the cup 130 to facilitate axial displacement of the shaft 120 relative to the housing 110. The spring 140 is configured to bias the housing 110 away from the cup 130 along the longitudinal axis 102. In an exemplary embodiment, spring 140 is a compression spring that extends from a surface within the cup 130 to an opposing surface of the housing 110 (as seen in FIG. 8B). Additionally, spring 140 is positioned to surround shaft 120.

As is illustrated in FIGS. 8B and 9B and elsewhere in the figures, a wall portion 131 extends generally along the direction of the longitudinal axis and defines an annular recess for accommodating an end or end portion of the spring 140. Thus, the annular recess is positioned for limiting the axial and radial movement of the end of the spring 140. Similarly, the recess 188 in the housing is defined in part by a wall portion 189 that extends generally along the direction of the longitudinal axis and accommodates an end or end portion of the spring 140. Thus, the annular recess 188 is positioned for limiting the axial and radial movement of the end of the spring 140.

As is illustrated in FIGS. 8B and 9B, the cup and housing move relative to one another and cooperate to capture the spring 140. Preferably, there is at least some overlap between the walls 131, 189 of the cup 130 and the housing 110, respectively. This makes it possible to prevent or reduce ingress of contaminants into the area of the spring 140 or into the interior of the housing 110. Although the illustrated embodiment includes a cup wall extending within and surrounded by the housing wall, the cup wall can alternatively be configured for extending around and surrounding the housing wall.

A latching member, such as pawl 160, is actuated to engage a frame 108 for latching. The pawl 160 extends radially outwardly from the shaft 120 relative to the longitudinal axis 102 and along a radial axis 104 (FIG. 1C). As illustrated in FIG. 7E, a preferred embodiment of the pawl 160 comprises a roller 162, a surface 164, and an axle 166. As can best be seen in FIGS. 8B and 9B, the axle 166 is coupled to the surface 164 and the roller 162 is configured to surround the axle 166. Further, the roller 162 is mounted for rotational movement relative to the radial axis 104.

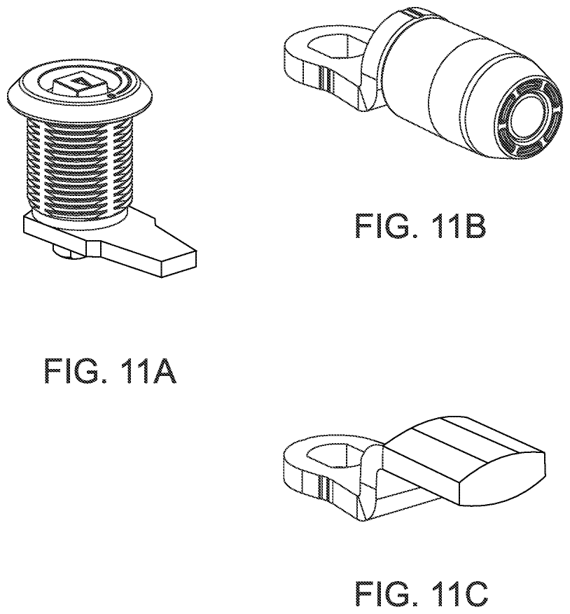

FIGS. 11A-11C depicts three embodiments of the latch 100 having a specific pawl 160. Preferably, as seen in FIG. 11A, the pawl 160 comprises a roller 162. This configuration may be desired for minimizing scratches or damage to the surface of the frame 108, for example. In FIGS. 11B and 11C, the flat surface of the pawl 160 may be desired for a stable engagement of frame 108, improved surface contact with frame 108, and minimal surface preparation of frame 108. Still further, the pawl 160 may be coupled to the shaft 120 using a fastening means, such as a screw 170. In an exemplary embodiment, pawl 160 is fixedly coupled to the lower end of shaft 130 via a screw 170 that is engaged with threaded recess 172 (FIG. 4D).

Pawl 160 is movable between a closed/latched position and an open/unlatched position. Pawl 160 is moved between the latched position and the unlatched position by rotation and axial movement of shaft 120. As illustrated in FIGS. 10A-10E, the pawl 160 is configured to engage or disengage the frame 108. In the close/latched position, shown in FIGS. 9A-9B and 10C and 10E, pawl 160 engages frame 108 and fixes panel 106 relative to frame 108. In the open/unlatched position, shown in FIGS. 8A-8B and 10A, 10B, and 10D, pawl 180 disengages from frame 108, and allows relative movement of panel 106 relative to frame 108.

An exemplary operation of latch system 300 comprising panel 106, frame 108, and latch 100 is described below with respect to FIGS. 8A-10E. As will be evident from the description below, the cam surface 180 is configured to guide the rotation and axial movement of shaft 120 as it is rotated within housing 110, such that pawl 160 engages with or disengages from frame 108. Further, it will be understood that the unlatching action of latch 100 is generally the reverse of the latching action.

The latch 100 according the present invention may be actuated between an unlatched state and a latched state, the latched state further including a locked or secured (compressed) state. In the open or unlatched position, the panel 106 is unlatched relative to the frame 108. In the closed or latched position, the panel 106 is latched relative to the frame 108. In the locked position, the panel 106 is pulled against the frame 108 such that they are compressed against one another (as illustrated in FIGS. 10C and 10E).

As a general overview, the drive stud 122 corresponds to a driver (not shown). The drive stud 122 is configured to enable a user to drive or rotate the shaft 120 relative to the housing 110, such that the cam surface 180 defined by the housing 110 guides the rotation and axial movement of the shaft 120. As the shaft 120 is rotated within the housing 110, the pawl 160 engages the frame 108 to a latched position in which the panel 106 is latched relative to the frame 108, and to a locked position in which the panel 106 is pulled against the frame 108 such that they are compressed against one another (FIGS. 10C and 10E). The shaft 120 may also be rotated within the housing 110, such that the pawl 160 disengages the frame 108 to an open position in which the panel 106 is unlatched relative to the frame 108 (FIGS. 10A, 10B, and 10D).

As noted above, the shaft 120 is operatively connected to the pawl 160. In one embodiment of the present invention, this may be accomplished with the pin 150 being configured to move along the cam surface 180 of housing 110, so as to rotate the pawl 160 in response to rotation of the shaft 120 from the unlatched position to the latched position and vice versa. Further, the latch 100 may be configured such that the shaft 120 and the pawl 160 rotate in unison. The housing 110 remains stationary relative to the panel 106 during actuation of the shaft 120.

Additionally, the latch 100 may be configured so that the shaft 120 shifts axially along the aperture 112 toward an end of the housing 110 (the upper end as illustrated in FIG. 8A for example) as the latch 100 moves from the unlatched position toward the latched position. The cup 130 is mounted for axial movement relative to the housing 110 and the spring 140 is sized to be received within cup 130. As noted above, the sliding engagement of pin 150 with the cam surface 180 of the housing 110 causes the pawl 160 to engage the frame 108. As the pawl 160 engages the frame 108, the spring 140 compresses within cup 130 while the cam surface facilitates the direction of the axial movement of shaft 120 relative to housing 110. The sliding engagement of pin 150 and the cam surface 180 is further described below.

The cam surface 180 defined by the housing 110 directs the movement of shaft 120 within housing 110 during an opening/unlatching or closing/latching operation of latch 100, as described in greater detail below. The housing 110 includes a cam surface 180 having surface portions that form a ramp section 182, an indentation section 184, and a plateau section 186 (as seen in FIG. 3E). The cam surface 180 guides the rotation and axial movement of the shaft 120. More particularly, the cam surface 180 contacts the end regions 152 of the pin 150, which extends radially outwardly relative to the longitudinal axis 102 of the shaft 120 and are positioned on either side of shaft 120. Actuation of the latch 100 thereby rotates the shaft 120 about the longitudinal axis 102, such that the pin 150 makes contact with the cam surface 180.

Specifically, actuation of the shaft 120 allows for sliding movement of pin 150 along each of ramp section 182, indentation section 184, and plateau section 186. In a preferred embodiment, the cam surface 180 is comprised of a pair of symmetrical ramp sections 182, indentation sections 184, and plateau sections 186, with each section configured to make contact with one of the end portions 152 of the shaft 120. In the latching action of the latch system 300, the ramp section 182 allows movement of at least one end portion 152 of the pin 150, and correspondingly shaft 120, in the axial direction relative to the housing 110. As a result, shaft 120 moves in the axial direction away from or axially relative to cup 130 (with the force of biasing means, such as spring 140). This axial movement of shaft 120 moves pawl 160 axially upward and toward the frame 108. The axial movement of pin 150 proceeds until pin 150 reaches the indentation section 182 and the plateau section 184, after which movement of pin 150 and shaft 120 is possible. As shown in FIGS. 9A-9B and 10A-10E, as shaft 120 is rotated, the pawl 160 moves to engage frame 108, such that roller 162 rotates relative to the radial axis 104 (FIG. 1C).

As shown in FIGS. 8A and 9A, full rotation of shaft 120 constitutes moving the pawl 160 approximately 90° from the either the open or closed position, as shown by the difference between indicators 200. It will be understood, however, that the rotational distance between the fully open/unlatched and the fully closed/latched and locked position may be any desired distance or angle of rotation.

In one embodiment of the present invention, the latched position includes the pawl 160 in a locked or secured position, in which the pawl 160 is compressed against frame 108, thereby maintaining the position of the panel 106 relative to the frame 108 (FIGS. 10A-10E). More particularly, FIGS. 9B and 10D-10E show latch 100 in in the closed or latched and locked position, wherein the pawl 160 is impeded by the frame 108. As shown in FIG. 10E, pawl 160 is rotated to engage with frame 108 in the latched position. As shown in FIG. 9B, indicator 200 is aligned with directional indicator 126, indicating to the user that pawl 160 is in the locked and latched position. At this stage and as shown in FIG. 9B, shaft 120 is at an axially uppermost position, with drive stud 122 being positioned along the same plane as the end or top of the flanged portion 116. Additionally, spring 140 within the cup 130 is fully compressed.

To move from the latched position to the unlatched position, it will be understood that the unlatching action of the latch system 300 comprising latch 100 is generally the reverse of the latching action described above. A user engages drive stud 122 of shaft 120 and begins rotating. The rotation of shaft 120 causes a corresponding movement of the pin 150 along the cam surface 180. As shaft 120 is rotated, the pawl 160 moves away from the frame 108 and rotates toward the open or unlatched position, such that roller 162 rotates relative to the radial axis 104 (FIG. 1C). Similarly, as with the latching action, the rotation capability of the unlatching action is preferably to be restricted to about 90 degrees.

As shown in FIG. 8A, indicators 200 remains aligned with directional indicator 126, but this time, indicating to the user that pawl 160 is in the unlatched position, as shaft 120 has been rotated clockwise from the closed position. As shown in FIG. 8B, shaft 120 is at an axially lowermost position, with spring 140 within cup 130 fully extended or decompressed. At the end of the axial displacement of the pawl 160, the pawl 160 is no longer impeded by the frame 108, thereby allowing a user to pull the panel 106 away from the frame and access the interior of an enclosure, for example.

While the exemplary embodiment in FIGS. 8A-10E (and elsewhere herein) depict a counterclockwise rotation of the shaft 120 from the unlatched to the latched position, it will be understood that the operations described herein may alternatively be performed with a clockwise rotation of the shaft 120. Still further, in the present embodiment, the components of the latch 100 are preferably comprised of metal and metal alloy materials; however, other suitable materials can also be used where desired, such as plastic. In addition, as would be appreciated by those of skill in the art, other driving means may be used to actuate a latch mechanism made according to the various embodiments of the present invention. For example, in applications in which security is not a concern, the driver may be a handle or knob attached to the latch mechanism to eliminate the need for a tool to operate the latch mechanism.

As noted previously, the exemplary latches described herein make it possible to maintain or improve performance, reduce cost and/or the number of components, and/or facilitate manufacturing while at the same time maintaining at least one of or all of (1) suitable pull-up or stroke of the latch's pawl, (2) smooth operation, and (3) adequate compressive force.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A latch configured to fix a panel relative to a frame, the latch comprising:
a housing configured for engagement to the panel, the housing defining an aperture extending along a longitudinal axis, and the housing further defining a cam surface facing in a direction along the longitudinal axis;
a shaft extending within the aperture of the housing and along the longitudinal axis, the shaft being mounted for at least one of rotational movement relative to the housing about the longitudinal axis and axial movement relative to the housing along the longitudinal axis;
a barrier wall mounted for axial movement relative to the housing along the longitudinal axis, the barrier wall at least partially overlapping with the housing along the longitudinal axis; and
a shaft surface extending radially outwardly from the shaft relative to the longitudinal axis, the shaft surface contacting the cam surface defined by the housing, the shaft being configured to be coupled to a pawl for engagement of the frame;
wherein the cam surface defined by the housing is configured to guide the movement of the shaft relative to the housing along the longitudinal axis or about the longitudinal axis as the shaft is moved within the aperture defined by the housing along the longitudinal axis or about the longitudinal axis and as the shaft surface of the shaft and the cam surface of the housing move relative to one another, such that the pawl can engage or disengage the frame; and
wherein the barrier wall and the housing move relative to one another along the longitudinal axis in a range of relative positions and the barrier wall and housing together inhibit the ingress of unwanted materials into the aperture of the housing throughout the range of relative positions.

2. The latch of claim 1, wherein the shaft comprises a drive stud extending along the longitudinal axis and defining a drive surface for rotating the shaft relative to the housing.

3. The latch of claim 2, wherein the drive stud is provided with a directional indicator corresponding to a position of the pawl.

4. The latch of claim 1, wherein the shaft is coupled to the pawl for engagement of the frame, and the pawl extends radially outwardly from the shaft relative to the longitudinal axis along a radial axis and includes a roller mounted for rotational movement about the radial axis.

5. The latch of claim 1, wherein the shaft is coupled to the pawl for engagement of the frame, and the pawl extends radially outwardly from the shaft relative to the longitudinal axis.

6. The latch of claim 1, wherein the cam surface of the housing comprises a plurality of sections, each section being configured to guide the movement of the shaft between a latched position and an unlatched position.

7. The latch of claim 1, wherein the cam surface and the housing are integrally formed as a single body of unitary construction.

8. The latch of claim 6, wherein the housing is provided with an indicator arrangement, the indicator arrangement corresponding to at least one of the unlatched position or the latched position.

9. The latch of claim 1, wherein the housing further comprises a recess configured to at least partially receive the barrier wall.

10. The latch of claim 1, further comprising a spring interposed between a surface of the housing and another surface of the latch, the spring being configured to bias the housing away from the other surface along the longitudinal axis;
wherein the spring is compressed as the shaft rotates toward a latched position.

11. The latch of claim 1, wherein the shaft surface is defined on a pin extending radially outwardly from the shaft relative to the longitudinal axis.

12. A latch configured for fixing a panel relative to a frame, the latch having an engaged position in which the panel is fixed relative to the frame and a disengaged position in which the panel is not fixed relative to the frame, the latch comprising:
a housing having a proximal end portion configured for engagement to the panel, the housing having a longitudinal axis;
a shaft extending along the longitudinal axis, the shaft and the housing being mounted for rotation relative to one another about the longitudinal axis, the shaft and the housing further being mounted for axial movement relative to one another;
a pawl coupled to a distal end portion of the shaft, the pawl being configured to engage the frame; and
a cam surface defined by the housing, the cam surface being configured to guide the axial movement of the shaft relative to the housing, such that the pawl engages or disengages the frame;
wherein the shaft and the pawl move together toward the proximal end of the housing upon rotation of the shaft relative to the housing as the latch transitions from the disengaged position toward the engaged position, thereby compressing the panel and the frame relative to one another.

13. The latch of claim 12 further comprising a barrier wall mounted for axial movement relative to the housing, the housing further comprising a recess configured to selectively receive at least a portion of the barrier wall.

14. The latch of claim 12 further comprising a spring, wherein axial movement of the pawl relative to the housing is configured to move the spring between an extended state and a compressed state.

15. The latch of claim 14, wherein the spring is interposed between a surface of the housing and another surface of the latch and is configured to bias the housing away from the other surface along the longitudinal axis.

16. The latch of claim 14, wherein the pawl engages or disengages the frame as the spring moves between the extended state and the compressed state.

17. The latch of claim 12, the shaft including a driver configured for engagement by a tool, the driver moving along the longitudinal axis as the shaft rotates relative to the housing.

18. The latch of claim 12, further comprising a pin extending radially outwardly from the shaft relative to the longitudinal axis, the pin being configured to contact the cam surface as the shaft and the housing rotate relative to one another about the longitudinal axis.

19. A latch system including the latch of claim 12, a panel engaged to the housing, a frame positioned for engagement by the pawl, and a gasket interposed between the panel and the frame, wherein the pawl compresses the gasket as the shaft and the pawl move together toward the proximal end portion of the housing upon rotation of the shaft relative to the housing as the latch transitions from the disengaged position toward the engaged position.

20. A latch configured to fix a panel relative to a frame, the latch comprising:
a housing configured for engagement to the panel, the housing having a longitudinal axis and an inner surface defining an aperture extending along the longitudinal axis, the housing further defining a cam surface on the inner surface of the housing and facing in a direction along the longitudinal axis, the cam surface and the housing being integrally formed as a single body of unitary construction;
a shaft extending within the aperture of the housing and along the longitudinal axis, the shaft being mounted for rotation relative to the housing about the longitudinal axis, the shaft further being mounted for axial movement relative to the housing along the longitudinal axis, the shaft having a shaft body and a shaft surface extending radially outwardly from the shaft body relative to the longitudinal axis, the shaft surface contacting the cam surface defined by the housing; and
a pawl coupled to the shaft, the pawl being configured to engage the frame;
wherein the cam surface defined by the housing is configured to guide the axial movement of the shaft relative to the housing along the longitudinal axis as the shaft is rotated within the aperture defined by the housing about the longitudinal axis and as the shaft surface of the shaft and the cam surface of the housing move relative to one another, such that the pawl engages or disengages the frame.

21. The latch of claim 20, further comprising a spring adjacent a surface of the housing, the spring being configured to bias the housing in a direction along the longitudinal axis.

22. The latch of claim 21, further comprising a cup mounted for axial movement relative to the housing along the longitudinal axis, the cup providing a barrier wall and defining an annular recess;

23. The latch of claim 22, wherein the spring is interposed between the surface of the housing and a surface of the cup and extending into the annular recess of the cup, the spring being configured to bias the housing away from the cup along the longitudinal axis.

24. The latch of claim 20, wherein the cam surface defined by the housing comprises a plurality of sections, each section configured to guide the axial movement of the shaft between a latched position and an unlatched position.

25. The latch of claim 20, wherein the shaft surface is defined on a pin extending radially outwardly from the shaft body relative to the longitudinal axis.

26. The latch of claim 20, wherein upon rotation of the shaft relative to the housing as the latch transitions from a disengaged position toward an engaged position, the shaft and the pawl move together toward a housing mounting plane at which the housing is configured to be mounted to the panel, thereby compressing the panel and the frame relative to one another.

27. The latch of claim 12, a position of a proximal end of the shaft relative to the proximal end portion of the housing providing a compression indicator.

28. The latch of claim 27, the compression indicator provided by the position of the proximal end of the shaft relative to the proximal end portion of the housing indicating compression when the proximal end of the shaft corresponds in position to a proximal end of the housing or the proximal end of the shaft and the proximal end of the housing are within a predetermined spacing, and the compression indicator indicating incomplete compression when the proximal end of the shaft is spaced distally from the proximal end of the housing or the proximal end of the shaft and the proximal end of the housing exceed the predetermined spacing.

29. The latch of claim 24, one of the plurality of sections of the cam surface defining a recess positioned to receive the shaft surface of the shaft, the recess being configured to releasably retain the shaft in a predetermined position or to provide haptic feedback to a user of the latch regarding the predetermined position.

30. The latch of claim 1, the housing being die cast, machined, injection molded, or printed.

31. The latch of claim 1, the cam surface of the housing being co-molded or pressed into the housing.

32. The latch of claim 1, the housing being formed from zinc or metal injection molded steel.

33. The latch of claim 1, the shaft and the housing being formed from the same material.

34. The latch of claim 1, the shaft surface of the shaft being formed from hardened steel.

35. The latch of claim 3, wherein the directional indicator indicates the position of the pawl in every position of the pawl.

36. The latch of claim 2, wherein a torque required to rotate the shaft relative to the housing and to compress the panel relative to the frame is 7.9 Nm or less, thereby permitting hand-rotation of the shaft relative to the housing and compression of the panel relative to the frame.

37. A latch configured to fix a panel relative to a frame, the latch comprising:
a housing configured for engagement to the panel, the housing having a longitudinal axis and an inner surface defining an aperture extending along the longitudinal axis from a proximal end of the housing to a distal end of the housing, the housing further defining a cam surface on the inner surface of the housing and facing in a proximal direction toward the proximal end of the housing along the longitudinal axis;
a shaft extending within the aperture of the housing and along the longitudinal axis, the shaft being mounted for movement relative to the housing;
a cam follower coupled to the shaft for movement with the shaft relative to the housing, the cam follower having a surface extending radially outwardly from the shaft body relative to the longitudinal axis, the surface of the cam follower contacting the cam surface defined by the housing;
wherein the shaft is configured for insertion distally into the aperture of the housing from the proximal end of the housing toward the distal end of the housing, and the cam follower is configured for insertion distally into the aperture of the housing from the proximal end of the housing toward the distal end of the housing, the shaft and the cam follower being prevented from insertion proximally into the aperture of the housing from the distal end of the housing toward the proximal end of the housing and from withdrawal distally from the aperture of the housing through the distal end of the housing; and
wherein the shaft and the cam follower are each insertable into the aperture of the housing in the distal direction.

38. The latch of claim 37, the cam surface and the housing being integrally formed as a single body of unitary construction.

39. The latch of claim 37, the cam follower being a separate component mounted to the shaft, the mounting of the cam follower to the shaft being configured to resist or prevent rotation of the cam follower relative to the shaft.

40. The latch of claim 39, the cam follower being a pin extending from an aperture defined in the shaft, at least one end of the pin extending radially outwardly from the shaft relative to the longitudinal axis.
